(19) United States
(12) Patent Application Publication
(10) Pub. No.: US 2026/0161942 A1
(43) Pub. Date: Jun. 11, 2026

(54) BIDIRECTIONAL STATE PREDICTION FOR PLANNING TASKS

(71) Applicant: GDM Holding LLC, Mountain View, CA (US)

(72) Inventors: Varun Yerram, Karnataka (IN); Sravanti Addepalli, Karnataka (IN); Karthikeyan Shanmugam, Karnataka (IN); Arun Sai Suggala, Karnataka (IN); Prateek Jain, Bangalore (IN)

(21) Appl. No.: 19/348,313

(22) Filed: Oct. 2, 2025

(30) Foreign Application Priority Data
Oct. 2, 2024 (IN) 202411074515

(51) Int. Cl. G06N 3/08

(52) U.S. Cl. CPC G06N 3/08

(57) ABSTRACT

Systems, methods, and computer program code to assist in performing planning tasks. An example planning task is to guide the actions of an agent so that the agent can perform a particular task. This involves obtaining an observation of a first state of an environment and a definition of a target state of the environment, and predicting representations of one or more intermediate states of the environment. The technique involves bidirectional predictions, i.e. both forward and reverse state predictions, and in implementations recursively updates a predicted state of the environment, which can be referred to as a goal state.

### CROSS-REFERENCE TO RELATED APPLICATION

This application claims priority to and the benefit of Indian Patent Provisional Application No. 202411074515, filed on Oct. 2, 2024, the disclosure of which is incorporated herein by reference in its entirety.

### BACKGROUND

This specification relates to controlling agents using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters, e.g. weights.

### SUMMARY

This specification describes systems to assist in performing planning tasks. Such a planning task can be to guide the actions of an agent so that the agent can perform a particular task. The agent can be, e.g., a mechanical agent, such as a robot acting in a real-world environment, or a software agent, or any other agent, e.g. an autonomous agent.

In one aspect there is described a method and a corresponding system, implemented as computer programs on one or more computers in one or more locations, for using one or more neural networks to assist in performing planning tasks.

In general the method can involve obtaining an observation of a first (initial) state of an environment, obtaining a definition of a target state of the environment, and predicting representations of one or more intermediate states of the environment between the first state and the target state.

A result of the method can be representations for each of a sequence of intermediate states that lead from the first state to the target state, e.g. so that an agent can chart a course of action to achieve the target state.

Broadly, the techniques involve both forward and reverse state predictions recursively updating a predicted state of the environment, which can be referred to as a goal state. As described later, such a goal state can be either an updated current reverse state or updated current forward state. The predictions converge to define the sequence of intermediate states. Confidence scores of the predictions can be used to increase the likelihood of convergence.

The forward and reverse state predictions are made by one or more (trained) neural networks. For example the same neural network (appropriately fine-tuned) can be used for both the forward and reverse state predictions. The neural network(s) system can include a Transformer neural network. In some implementations the neural network(s) comprise an autoregressive neural network that processes an input sequence of tokens to sequentially generate an output sequence of tokens. The neural network(s) can comprise a so-called large language model (LLM), or vision language model (VLM).

Particular embodiments of the subject matter described in this specification can be implemented so as to realize one or more of the following advantages.

LLMs have shown success in many tasks but their application to planning remains largely unsolved, particularly when longer term prediction is involved. Although their performance can be improved by fine-tuning the model on examples of a particular problem, typically the model fails to generalize to the same type of problem with greater complexity, or to related problems.

Implementations of the described techniques use bidirectional state prediction to alternately predict states in the forward and reverse directions, e.g. using fine-tuned LLMs or VLMs, recursively updating their respective goal states. In this way they can solve a progressively shorter problem and, optionally, can produce a final complete plan by meeting in the middle. This facilitates both longer term prediction, and generalization.

In some implementations the condition of a monotonic increase in prediction probability of a given state, as the goal state gets closer, can be used, e.g. to reject a state or to select the best among several sampled states at a planning step. This can improve the efficiency of solving the planning problem, and can help in better generalizing to related problems, e.g. those unseen during training (fine-tuning).

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of a neural network system for performing a planning task.

FIG. 2 is a flow diagram of an example process for assisting in a planning task.

FIG. 3 shows an example of a planning task.

FIG. 4 is a visualization of a technique for bidirectional planning.

Like reference numbers and designations in the various drawings indicate like elements.

### DETAILED DESCRIPTION

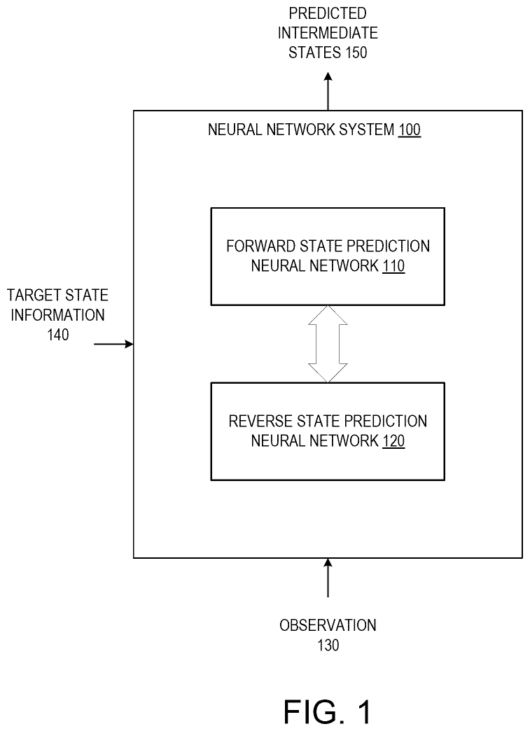

FIG. 1 shows an example of a system 100 that may be implemented as one or more computer programs on one or more computers in one or more locations, for performing bidirectional state prediction for planning.

The system 100 comprises a forward state prediction neural network 110 and a reverse state prediction neural network 120. The system is configured to receive an observation 130 of a first state of an environment, and information 140 that defines a target state of the environment. The system generates an output 150 that defines one or more intermediate states of the environment between the first state and the target state. The system 100 can be configured to implement a method of planning, as described in detail below.

In general the forward state prediction neural network 110 and the reverse state prediction neural network 120 can have any appropriate architecture, e.g. including one or more feed forward neural network layers, one or more recurrent neural network layers, one or more convolutional neural network layers, one or more attention neural network layers, one or more normalization layers, and so forth.

In some implementations the forward state prediction neural network 110 and the reverse state prediction neural network 120 may each comprise a sequence processing model, e.g. a sequence-to-sequence model, configured to process an input sequence of tokens to generate an output sequence of tokens. For example the forward state prediction neural network 110 and/or the reverse state prediction neural network 120 may each comprise an auto-regressive generative model (e.g., a Transformer, a recurrent neural network, etc.) that can auto-regressively generate an output sequence of tokens from an input sequence of tokens. For example, the neural network(s) can each comprise a foundation model such as a large language model (LLM) that can auto-regressively generate tokenized representations of text data, or a vision-language or multimodal model (VLM) that can auto-regressively generate tokenized representations of text and images or video, or in some implementations audio.

In some implementations the (trained) reverse state prediction neural network 120 and the (trained) forward state prediction neural network 110 are the same neural network, i.e. the same neural network, e.g. LLM or VLM, can be used for both.

In some implementations the reverse state prediction neural network 120 comprises a time-reversed sequence-to-sequence model, such as a time-reversed LLM or VLM. Here time reversal refers to reversing an order of (tokens in) a sequence of tokens used to represent an input to the model, e.g. reversing an order of words or other text input to the model. Thus an input to such a model comprises a time-reversed, i.e. order-reversed, sequence of tokens. The sequence of tokens generated by the model can also be (but need not be) order-reversed.

Such a model can have been pre-trained in the forward direction, i.e. using tokens with a usual, forward order, in the order-reversed direction, or both. That is, training in the order-reversed direction is optional. The model can be fine-tuned using queries with order-reversed tokens followed by responses, which can also comprise order-reversed token sequences.

In such implementations processing the representation of the current reverse state of the environment, and either the representation of the current state of the environment or the representation of the next forward state of the environment, using the reverse state prediction neural network 120 can involve reversing an order of the sequence of tokens representing the current reverse state of the environment. The order of the sequence of tokens representing the current state of the environment or the next forward state of the environment, respectively, can also be reversed. An order of concatenation of the representation of the current reverse state of the environment and of the representation of the current state/next forward state of the environment need not be reversed (though it may be).

In some implementations the reverse state prediction neural network 120 and the forward state prediction neural network 110 each comprises a Transformer neural network.

In general a Transformer neural network is characterized by having a succession of attention, e.g. self-attention neural network layers. A self-attention neural network layer has an attention layer input for each element of the input and is configured to apply an attention mechanism over the attention layer input to generate an attention layer output for each element of the input. There are many different attention mechanisms that may be used. For example, a self-attention layer can be one that maps a query and a set of key-value pairs, each derived from an input to the self-attention layer (e.g. all vectors), to an output from which an output of the self-attention layer is derived. The output can be computed as a weighted sum of the values, weighted by a similarity function of the query to each respective key.

In general a Transformer neural network as described herein receives a sequence of input tokens and is configured to apply the succession of attention neural network layers to the input sequence to generate a sequence of output tokens that comprises a transformed input element for each element of the sequence of input tokens.

The Transformer neural network can be (but need not be) a causal Transformer neural network e.g., an encoder-decoder Transformer neural network with a causal Transformer decoder or a causal decoder-only Transformer neural network. An example of a Transformer neural network is described in Vaswani et al., 2017 arXiv: 1706.03762.

In some implementations, rather than there being a separate forward state prediction neural network 110 and reverse state prediction neural network 120, the forward state prediction neural network 110 and reverse state prediction neural network 120 may comprise the same (shared) state prediction neural network, e.g. a pre-trained LLM or VLM. That is, the functions of these two neural networks may be performed by the same, shared, state prediction neural network, also referred to later as simply “the state prediction neural network”.

Merely as some examples, the reverse state prediction neural network 120, the forward state prediction neural network 110, or the state prediction neural network, may comprise a multimodal model, e.g. a VLM, such as Flamingo (Alayrac et al. arXiv: 2204.14198); ALIGN (Jia et al., arXiv: 2102.05918); PaLI (Chen et al. arXiv: 2209.06794); PaLI-X (Chen et al. arXiv: 2305.18565); a model from the Gemini family; or a model from the Gemma family; or an LLM such as a model from the T5 family.

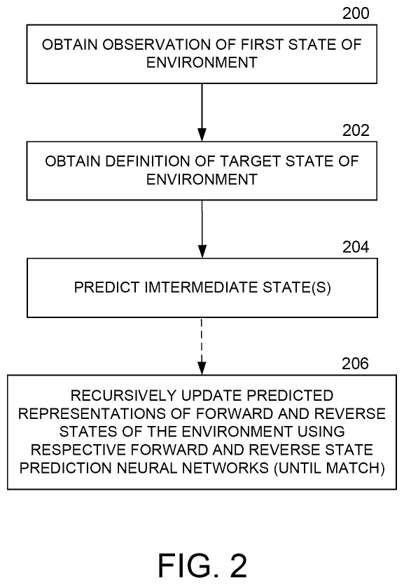

FIG. 2 is a flow diagram of an example process for using a neural network system to perform a planning task. The process can be performed by a system of one or more computers located in one or more locations, and for convenience will be described as performed by the system 100 of FIG. 1.

Implementations of the process obtain an observation of a first, initial state of an environment (step 200). The process can also obtain a definition of a target state of the environment (step 202).

As described further later, the first state and the target state can be defined at varying levels of specificity. For example in a robot movement planning task or code writing task these states may represent the state of the robot or task, or of one or more objects or data manipulated by the robot or code. In an itinerary or other planning task the first state may represent a specification of the planning problem or task, in effect a placeholder or null state (leaving flexibility for the system to define the second state), and the target state may represent completion of the planning problem or task e.g. according to defined constraints.

The process predicts representations of one or more intermediate states of the environment between the first state and the target state (step 204). In general this can involve recursively updating predicted representations of forward and reverse states of the environment using respective forward and reverse state prediction neural networks, e.g. until the predicted states match (step 206).

In more detail, in implementations predicting the representations of the one or more intermediate states of the environment involves using the reverse state prediction neural network 120 and the forward state prediction neural network 110 at one or more planning iterations.

More specifically one approach can involve updating a representation of a current reverse state of the environment by processing the representation of the current reverse state of the environment and a representation of a current forward state of the environment using the reverse state prediction neural network 120 to generate a representation of a predecessor state to the current reverse state.

The representation of the current forward state of the environment can be updated by processing the representation of the current forward state of the environment and the representation of the predecessor state of the environment using the forward state prediction neural network 110 to generate a representation of a next forward state after the current forward state. The predecessor state is the updated current reverse state, and can be referred to as a goal state where, during the iterations, the goal state gradually approaches the first state.

Another approach can involve updating a representation of a current forward state of the environment by processing the representation of the current forward state of the environment and a representation of a current reverse state of the environment using the forward state prediction neural network 110 to generate a representation of a next forward state after the current forward state.

The representation of the current reverse state of the environment can be updated by processing the representation of the current reverse state of the environment and the representation of the next forward state of the environment using a reverse state prediction neural network 120 to generate a representation of a predecessor state to the current reverse state. The next forward state is the updated current forward state, and can be referred to as a goal state where, during the iterations, the goal state gradually approaches the target state.

At a first iteration the current forward state of the environment can be the first state of the environment. At a first iteration the current reverse state of the environment can be the target state of the environment.

For example, a first iteration can involve predicting the second state from the first and from the predecessor of the target state (goal state); or predicting the predecessor of the target state from the next state after the first state (goal state).

In implementations each of the one or more intermediate states corresponds to a respective planning step, the next forward state corresponds to a next planning step after the planning step for the current forward state, wherein the predecessor state to the current reverse state corresponds to a previous planning before the planning step for the current reverse state.

The process can provide representations for each of a sequence of intermediate states that lead from the first state to the target state, e.g. for controlling actions of an agent.

The process can continue performing planning iterations until the representations of the current forward state of the environment and the current reverse state of the environment match, i.e. until the states “meet in the middle”. However this is optional.

Some implementations of the process involve generating, at each of the planning iterations, a confidence score associated with the representation of one of the intermediate states. Depending upon how the process is implemented this can be generated by either the forward state prediction neural network 110 or the reverse state prediction neural network 120, or in some other way.

As one example, the confidence score can represent a likelihood of the predicted representation. This can be used as a measure of confidence that the predicted representation is a useful link between the first and target states. As another example, the confidence score can represent so-called perplexity, i.e. a measure of uncertainty, where lower perplexity indicates greater confidence. Then the confidence score can be inversely related to the perplexity, e.g. in an implementation in which the confidence score is arranged to increase (see below).

The process can use the confidence score to guide the predicting of the representations of the one or more intermediate states of the environment. There are various ways in which this can be done. As one example, the confidence score can be required to increase with successive planning iterations (as the current forward and current reverse predicted states approach one another). Also or instead the process can sample multiple predicted representations (from the forward state prediction neural network or the reverse state prediction neural network), and can then select one of these for use depending on their confidence scores, e.g. picking the representation with the highest score.

In some implementations, guiding the predicting of the representations of the one or more intermediate states of the environment using the confidence score involves constraining the confidence score to increase monotonically over the planning iterations, e.g. by regenerating (resampling) one or more of the intermediate states of the environment when the confidence score for a planning iteration does not increase.

In some implementations the guiding can involve generating a plurality of representations of one of the intermediate states at each of the planning iterations, generating the confidence score for each of the plurality of representations, and selecting one of the plurality of representations using the generated confidence scores.

More specifically the process can involve, at a current planning iteration, processing the representation of the current forward state of the environment and the representation of the predecessor state using the forward state prediction neural network 110 to generate the representation of the next forward state and an associated confidence score for the next forward state at the current planning iteration.

Alternatively (or as well) the process can involve processing the representation of the current reverse state of the environment and the representation of the next forward state using the reverse state prediction neural network 120 to generate the representation of the predecessor state and an associated confidence score for the predecessor state at the current planning iteration.

In response to determining that the confidence score at the current planning iteration is not greater than the confidence score at a previous planning iteration the process can then resample (respectively) either the representation of the next forward state (the updated current forward state), or the representation of the predecessor state (the updated current reverse state).

In implementations the predictions generated by the forward state prediction neural network 110 and the reverse state prediction neural network 120 are stochastic, i.e. they do not generate the same prediction every time.

As another more specific example, the process can involve, at a current planning iteration, processing the representation of the current forward state of the environment and the representation of the predecessor state using the forward state prediction neural network 110 to generate a plurality of representations of the next forward state and associated confidence scores, and selecting one of the plurality of representations as the representation of the next forward state at the current planning iteration based on the associated confidence scores.

Alternatively (or as well) the process can involve processing the representation of the current reverse state of the environment and the representation of the next forward state using the reverse state prediction neural network 120 to generate a plurality of representations of the predecessor state and associated confidence scores, and selecting one of the plurality of representations as the representation of the predecessor state at the current planning iteration based on the associated confidence scores. As an example, a representation with a highest confidence score can be selected.

In some implementations one or more of the representation of the current reverse state of the environment, the representation of the current forward state of the environment the representation of the predecessor state, and the representation of the next forward state, each comprises a sequence of one or more tokens. As described later, the tokens can be processed by the or each neural network sequentially, e.g. autoregressively.

A “token” as used in this specification is a vector of numerical values having a specified dimensionality, i.e, the number of numerical values is constant across different tokens. Each token can comprise a respective predetermined or learned embedding (an ordered collection of numerical values having a pre-determined dimensionality.

Generally the tokens can represent text in a natural or formal, e.g. computer, language and or one or more still or moving images (video). The tokens can be hard tokens, e.g. selected from a vocabulary comprising a discrete set of tokens, or soft tokens, i.e. not tied to, or necessarily belonging to, a specific vocabulary of tokens. A data item may be tokenized by, for example, converting elements of the data item into respective tokens.

The observation of the first state of the environment can be processed using a tokenizer to obtain a first sequence of tokens representing the current forward state of the environment at the first iteration. The tokenizer can be implemented, e.g., using a fixed mapping or a neural network (e.g. for images).

The definition of the target state of the environment can be processed using a tokenizer to obtain a target sequence of tokens representing the current reverse state of the environment at the first iteration.

The observation of the first state of the environment, and the definition of the target state of the environment, can each comprise, e.g., one or more of text, a still or moving image, audio, sensor data (e.g. proprioceptive data of a mechanical agent), and in general any data appropriate to the environment in which the technique is being used. Some further examples are given later.

In some implementations the tokens can represent text, e.g., words, wordpieces or characters, in a natural or computer language. For example text may be received, e.g., as a series of encoded characters, e.g. UTF-8 encoded characters; such “characters” can include Chinese and other similar characters, as well as logograms, syllabograms and the like. A text encoder, i.e. a tokenizer, can process a sequence of text to represent the text as a series of text tokens from a vocabulary of text tokens, e.g. that each represent words, wordpieces or characters in a natural or computer language. The computer language may be any formal language used to communicate with a computer, e.g. a markup language, or a command or configuration language, or a data exchange language such as JSON, or a programming language. The tokenizer can, e.g., implement BPE (Byte Pair Encoding) or Wordpiece tokenization. In some implementations text can be obtained from audio data representing speech, using a speech recognition system.

Also or instead the tokens may represent an image. For example a set (sequence) of input or output tokens can represent an image. As one particular example each image token may comprise a block encoding of values of the pixels in a different region of an image that maps a set of values of the pixels to a respective image token. The block encoder may comprise a neural network, e.g. having one or more (self-) attention layers, such as a Transformer neural network.

Also or instead the tokens may represent an audio waveform. For example a set (sequence) of input or output tokens can represent audio data representing a waveform e.g. instantaneous audio amplitude values or time-frequency audio data. Each image token may comprise a block encoding of the audio waveform in a different time segment of the audio that maps a set of values representing the audio waveform to a respective image token. The block encoder may comprise a neural network, e.g. having one or more (self-) attention layers, such as a Transformer neural network.

The system may be multimodal system, e.g. it may process two or more of text data, audio, and an image; optionally audio or image tokens may be flagged by a start-of-audio token or start-of-image token.

Merely as an example, one particular algorithm to implement the above-described method of planning of FIG. 2 is given below:

Algorithm 1 BiSP-T: Bidirectional Planning with AR LLMs

| 1: | Input: FLLM(•) (Forward-LLM) , RLLM(•) (Reverse-LLM), Initial State s₀, End State e, | |
|---|---|---|
| | MDP (MDP Description as a text prompt), 2L - max plan length. | |
| 2: | Fwdplan = [s₀] | |
| 3: | Revplan = [e] | |
| 4: | | [symbol] Initialize List with index starting at 0 |

| 5: | for i ∈ 1 : L − 1 do | |
|---|---|---|
| 6: | Fwdplan ← Fwdplan.append(FLLM( \|MDP, Fwdplan[i − 1], Revplan[i − 1])) | |
| 7: | [symbol] Append FLLM generated next state based on last generated goal state by | |
| | RLLM | |
| 8: | Revplan ← Revplan.append(RLLM( \|MDP, Revplan[i − 1], Fwdplan[i − 1])) | |
| 9: | [symbol] Append RLLM generated penultimate state based on last generated start | |
| | state by FLLM | |
| 10: | if Fwdplan[i] ∈ Revplan[1 : i]\|\|Revplan[i] ∈ Fwdplan[1 : i] then | |
| 11: | Break out of for loop | [symbol] Meet in the middle criterion. |

| | |
|---|---|
| 12: | end if |
| 13: | end for |
| 14: | if i < L then |
| 15: | return Fwdplan + Revplan[:: −1] |
| 16: | else |
| 17: | return : “Feasible Plan not Found” |
| 18: | end if |
| 19: | [symbol] Return Forward Plan + reversed Reverse Plan if meet in the middle |
| | happens |

Merely as an example, one particular algorithm for using confidence scores when planning according to the method of FIG. 2 is given below:

Algorithm 2 BiSP-T: Bidirectional Planning with tracking improvements

| 1: | Input: FLLM(•) (Forward-LLM) , RLLM(•) (Reverse-LLM), Initial State s₀, End State e, | |
|---|---|---|
| | MDP (MDP Description as a text prompt), 2L - max plan length. maxstep - a parameter, | |
| 2: | Fwdplan = [s₀] | |
| 3: | Revplan = [e] | |
| | Initialize List with index starting at 0 | |
| 4: | for i ∈ 1 : L − 1 do | |
| 5: | for j ∈ 1 : maxstep do | |
| 6: | FwdCandidate = FLLM (~ \|MDP, Fwdplan[i − 1], Revplan[i − 1]) | |
| 7: | Fwdscore = FLLM.score(FwdCandidate\|MDP, Fwdplan[i − 1], Revplan[i − 1]) | |
| 8: | RevCandidate = RLLM (~ \|MDP, Revplan[i − 1], Fwdplan[i − 1]) | |
| 9: | Revscore = RLLM.score(RevCandidate\|MDP, Revplan[i − 1], Fwdplan[i − 1]) | |
| 10: | flag = 0 | |
| 11: | if Fwdscore < FLLM.score(FwdCandidate\|MDP, Fwdplan[i − 1], Revplan[i − 2]) | |
| | then | |
| 12: | Revplan[i − 1] ← RLLM ( \|MDP, Revplan[i − 2], Fwdplan[i − 2])) | |
| 13: | flag = 1 | |
| 14: | end if | |
| 15: | if Revscore < RLLM.score(RevCandidate\|MDP, Revplan[i − 1], Fwdplan[i − 2]) | |
| | then | |
| 16: | Fwdplan[i − 1] ← FLLM( \|MDP, Fwdplan[i − 2], Revplan[i − 2])) | |
| 17: | flag = 1 | |
| 18: | end if | |
| 19: | [symbol] If previous states of either LLM is not useful in terms of scores for | |
| | the other, resample the states until maxsteps. | |
| 20: | if flag == 0 then | |
| 21: | Break out of inner for loop. | |
| 22: | end if | |
| 23: | end for | |
| 24: | Fwdplan.append(FwdCandidate) | |
| 25: | Revplan.append(RevCandidate) | |
| 26: | [symbol] Append next state of either LLM based on last goal state by other LLM | |
| 27: | if Fwdplan[i] ∈ Revplan[1 : i]\|\|Revplan[i] ∈ Fwdplan[1 : i] then | |
| 28: | Break out of outer for loop. | [symbol] Meet in the middle criterion. |

| | |
|---|---|
| 29: | end if |
| 30: | end for |
| 31: | if i < L then |
| 32: | return Fwdplan + Revplan[:: −1] |
| 33: | else |
| 34: | return : “Feasible Plan not Found” |
| 35: | end if |
| | Return Forward Plan + reversed Reverse Plan if meet in the middle |
| | happens |

This example algorithm checks whether states generated using intermediate goals (i.e. the predecessor state of the environment to the current reverse state, or the next forward state of the environment after the current forward state) have higher confidence scores compared to the original goal (the current reverse state, or the current forward state), if not regenerating the intermediate goal.

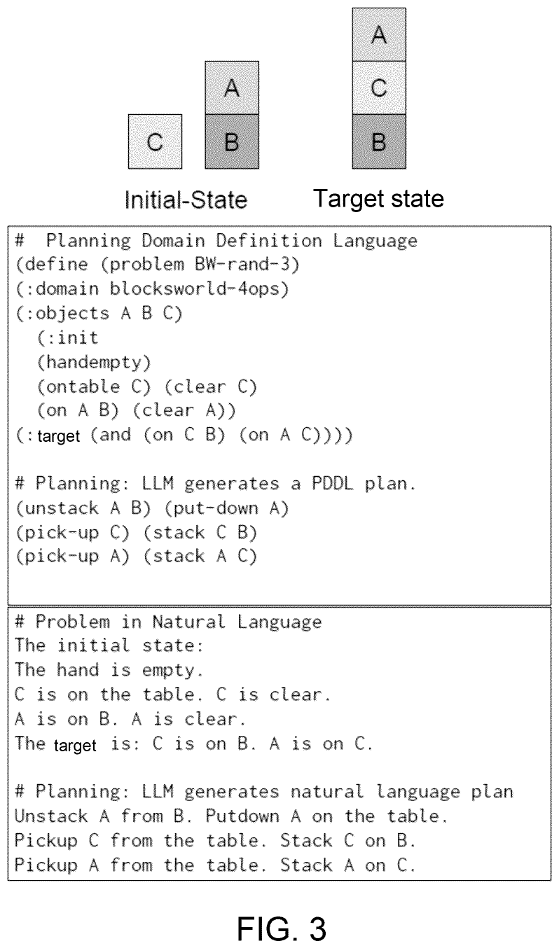

FIG. 3 shows an example of a planning task in a synthetic, “Blocks World” environment, showing an initial state and a target state represented in the formal PDDL (Planning Domain Definition Language) language (top), and in natural language (bottom). FIG. 3 is taken from Bohnet et al. “Exploring and Benchmarking the Planning Capabilities of Large Language Models”, arXiv: 2406.13094, which describes the use of LLMs for planning tasks. Another example of using an LLM for controlling a robot is described in “Do As I Can, Not As I Say: Grounding Language in Robotic Affordances”, Ahn et al., arXiv: 2204.01691, 2022. These examples illustrate one type of task in the context of which the techniques described herein can be used.

In some implementations generating the confidence score associated with a representation of a state of the environment involves determining a log likelihood value assigned to each token of the sequence of tokens representing the state of the environment (i.e. generated to represent the state of the environment by the relevant neural network. The log likelihood value can be obtained by taking the log of the probability of a token as determined by the relevant neural network.

The confidence score can be determined from a sum, in implementations an average, of the log likelihood values. As another example, the confidence score can represent an inverse perplexity value for a sequence of tokens for a representation. The perplexity value can be determined as an exponential of the average negative log likelihood of the tokens.

In some implementations processing two representations of a state of the environment using a neural network can involve processing a concatenation of the tokens for the representations.

As a more specific example, this can involve processing a concatenation of tokens representing the current reverse state of the environment and the current forward state of the environment, using the reverse state prediction neural network 120, to generate a sequence of tokens representing the predecessor state; and processing a concatenation of tokens representing the current forward state of the environment and the predecessor state, using the forward state prediction neural network 110, to generate a sequence of tokens representing the next forward state.

As another more specific example this can involve processing a concatenation of tokens representing the current forward state of the environment and the current reverse state of the environment, using the forward state prediction neural network 110, to generate a sequence of tokens representing the next forward state, and processing a concatenation of tokens representing the current reverse state of the environment and the next forward state of the environment, using the reverse state prediction neural network 120, to generate a sequence of tokens representing the predecessor state.

The result of the planning process is independently useful. For example, a result of the planning process can be used by a human to plan actions to perform to accomplish a task. As another example it can be used to assist another machine learning system in performing a task.

Nonetheless some implementations of the described techniques also involve determining a sequence of actions, based on the predicted intermediate states of the environment, for controlling an agent to progress through the intermediate states to reach the target state. Some examples of agents are described later.

Controlling the agent based on the predicted intermediate states of the environment can involve selecting actions for the agent to perform to transition from the first state of the environment to the target state of the environment via the predicted one or more intermediate states of the environment.

In some implementations the agent is a mechanical agent, and the environment is a real-world environment or a simulation of the real-world environment. The initial observation can then be of the real world environment or the simulation of the real-world environment. The process can then involve controlling the mechanical agent, based on the predicted intermediate states of the real-world or simulated environment, to reach the target state of the real-world environment, to perform a task. Merely as an illustrative example, a target state for a household robot could be a tidy room, e.g. a tidy kitchen state, represented as one or more still or moving images and/or text.

As a more detailed illustration, a (mechanical) robot movement planning task can involve determining states of a (mechanical) robot in a real world environment for the robot movement planning task. The robot movement planning task can be to move a part of the robot, e.g. an arm of the robot, and/or the entire robot, e.g. the task may include a navigation task. The observation of the first state of the environment can then include an observation of an initial state or configuration of the robot, e.g. of a part of the robot such as a robot arm, and/or of a location of the robot in a real-world environment. The definition of the target state of the environment can specify a target state or configuration of the robot, e.g. of a part of the robot such as a robot arm, and/or a target location of the robot in the real-world environment. The predicted representations can then specify of one or more intermediate states of the environment that the robot should adopt sequentially to arrive at the target state. To continue the example, also or instead the initial state and/or the target state can specify a state or configurations of or one or more objects to be moved or manipulated by the robot.

As another example, in an itinerary planning task the first state may effectively be unspecified, leaving flexibility for the system to pick the next state. For example the first state may comprise a specification of the planning problem or task, in effect a placeholder or null state. The target state can be defined as there being an itinerary regarding the order of visiting N different locations e.g. according to defined constraints. The intermediate states can define the locations visited. For example an itinerary planning task can be defined as (including the prompt): “You plan to visit 3 European cities for 14 days in total. You only take direct flights to commute between cities. You would like to visit Florence for 6 days. You want to meet a friend in Florence between day 9 and day 14. You would like to visit Barcelona for 5 days. You would like to visit Helsinki for 5 days. Here are the cities that have direct flights: Barcelona and Florence, Helsinki and Barcelona. Find a trip plan of visiting the cities for 14 days by taking direct flights to commute between them”. The intermediate states can be, e.g. “Arrive in Helsinki and visit Helsinki for 5 days”, “Fly from Helsinki to Barcelona”, “Visit Barcelona for 5 days”, “Fly from Barcelona to Florence”, “Visit Florence for 6 days”.

As another example, in a meeting planning task, the initial state may be open and the target state can be defined as one that provides meeting times and locations for N friends. For example a meeting planning task can be defined as (including the prompt): “You arrive at SOMA (South of Market) at 9:00 AM. Joseph will be at Alamo Square from 4:15 PM to 6:30 PM. You′d like to meet Joseph for a minimum of 105 minutes. Andrew will be at Haight-Ashbury from 4:30 PM to 6:15 PM. You′d like to meet Andrew for a minimum of 30 minutes. John will be at Nob Hill from 7:15 AM to 11:00 AM. You′d like to meet John for a minimum of 75 minutes. It takes 27 minutes to travel between Sunset District and Nob Hill via car. It takes 18 minutes to travel between Sunset District and Alamo Square via car. It takes 11 minutes to travel between Sunset District and Golden Gate Park via car. It takes 25 minutes to travel between Nob Hill and Sunset District via car. It takes 11 minutes to travel between Nob Hill and Alamo Square via car. It takes 18 minutes to travel between Nob Hill and Golden Gate Park via car. It takes 16 minutes to travel between Alamo Square and Sunset District via car. It takes 11 minutes to travel between Alamo Square and Nob Hill via car. It takes 9 minutes to travel between Alamo Square and Golden Gate Park via car. It takes 10 minutes to travel between Golden Gate Park and Sunset District via car. It takes 19 minutes to travel between Golden Gate Park and Nob Hill via car. It takes 10 minutes to travel between Golden Gate Park and Alamo Square via car.” The intermediate states can be, e.g., “start at SOMA (South of Market) at 9:00 AM”, “travel to Nob Hill in 10 minutes and arrive at 9:10 AM”, “meet John for 75 minutes from 9:10 AM to 10:25 AM”, “travel to Alamo Square in 11 minutes and arrive at 10:36 AM”, “wait until 4:15 PM”, “meet Joseph for 105 minutes from 4:15 PM to 6:00 PM”. A logistics planning task can be similarly defined.

As another example in a calendar scheduling task, the initial state may be open and the target state can be defined as one that provides meetings between multiple people given existing schedules and constraints.

The forward state prediction neural network 110 and the reverse state prediction neural network 120 can have been trained to perform one or more planning problems or tasks, e.g. a particular planning problem or task that the system is used to perform. However that is not essential.

The forward state prediction neural network 110 and the reverse state prediction neural network 120 can be implemented by (trained) LLMs or VLMs. These can perform a planning task without further training, or they can be fine-tuned for planning tasks. Particularly in implementations where the forward and reverse state prediction neural networks 110, 120 are implemented by one or more LLMs or VLMs, the planning problem or task can be defined in a prompt for LLMs or VLMs. Such a prompt can include the definition of the planning problem or task, and optionally one or more examples that show similar tasks performed, to illustrate to the model how the task should be performed.

In some implementations the reverse state prediction neural network 120 and the forward state prediction neural network 110 comprise the same (shared) state prediction neural network, e.g. a pre-trained LLM or VLM. The pre-trained LLM or VLM can perform a state prediction task as described herein without further training, e.g. by providing the model with a prompt containing one or more examples or “shots” of the type of state prediction task to be performed (“in-context learning”). Also or instead the reverse state prediction neural network 120 and the forward state prediction neural network 110, e.g. the same, shared state prediction neural network, can be trained to perform the state prediction task.

Where an LLM or VLM is used, training the reverse state prediction neural network 120 and the forward state prediction neural network 110 can involve fine-tuning an existing, pre-trained model. In general the reverse state prediction neural network 120 and the forward state prediction neural network 110, or the (shared) state prediction neural network, can be trained on actual or synthetic data (simulated planning tasks). The training can involve gradually increasing a difficulty of the training examples.

Where an LLM or VLM is used the training (fine-tuning) can be based on a conventional next token prediction task. For other neural networks the training can be based on any objective that measures successful performance of a planning task. As one example, this can involve determining a measure of difference between a result of a planning task from the system and a result of a planning task in a training example. As another example this can involve verifying the result of the planning task from the system using a verifier, such as Howey et al. “VAL: automatic plan validation, continuous effects and mixed initiative planning using PDDL” IEEE International Conference on Tools with Artificial Intelligence, 2004; or any other suitable tool. For example, natural language can be mapped back to a formal language such as PDDL, for verification, using regular expressions.

Where a prompt is used each example or “shot” in the prompt can include a planning problem, e.g. definitions of an initial state and a target state of an environment, and an example of the desired output, e.g. a next (forward) predicted state or a predicted predecessor state, followed by the actual planning problem, e.g., a definition of an initial state (from an observation of the environment of the actual planning problem) and a definition of the target state. The LLM or VLM can then generate the required prediction.

In some LLM or VLM-based implementations training (e.g. fine-tuning) rather than prompting may produce better results.

In more detail, a method of training the reverse state prediction neural network 120, the forward state prediction neural network 110, or the state prediction neural network, can involve obtaining a training dataset comprising a plurality of example planning tasks. Each planning task can comprise a sequence of states of an (e.g. approximately the same) environment at respective a sequence of respective planning steps, leading from an initial state of the environment to a target state of the environment.

The example planning tasks can be of the same general type to tasks the system will, after training, be used to perform. For example, the example planning tasks can comprise states of a (mechanical) robot in either a real-world or a simulated environment for a (mechanical) robot movement planning task. For the previously described trip itinerary planning, meeting planning, or calendar scheduling the example planning tasks can comprise examples of trip itineraries, example of meeting planning, or examples of calendar scheduling, e.g. as used in the Natural Plan benchmark, described in Zheng et al. 2024, arXiv: 2406.04520. As another example, for a logistics task the PDDL examples from the 1st International Planning Competition, 1998 can be used (IPC-1998; github.com/potassco/pddl-instances/tree/master/ipc-1998). In general the training can be on synthetic (simulated) or real data, which facilitates generating training data for any particular task as needed (e.g. as described in Zheng et al., ibid).

The reverse state prediction neural network 120 can be trained using a plurality of the example planning tasks. For each example planning task this can involve generating, from the example planning task, a training example comprising a representation of a first state of the environment (selected from the sequence of states of the environment), at a first planning step, and a representation of a second state of the environment (selected from the sequence of states of the environment) at a second, later, e.g. next planning step.

The reverse state prediction neural network 120 can then be trained to process the representation of the second state of the environment to generate the representation of the first state of the environment. In some implementations this can involve determining respective representations of the first and second states of the environment, e.g. as sequences of tokens. The reverse state prediction neural network 120 can then be trained using a conventional token-predicting objective (such as a softmax cross entropy loss or an autoregressive negative log likelihood loss), e.g. by backpropagating gradients of the objective through the neural network.

The forward state prediction neural network 110 can be trained in a corresponding manner.

When a single state prediction neural network is used this can be trained for both forward and reverse prediction tasks. This can use a plurality of the example planning tasks, which may be the same as or different from those used to train the reverse state prediction neural network.

For each example planning task this can involve generating, from the example planning task, a training example comprising a representation of a third state of the environment at a third planning step and a representation of a fourth state of the environment at a fourth, later, e.g. next planning step. The state prediction neural network can then be trained to process the representation of the third state of the environment to generate the representation of the fourth state of the environment. The third and fourth states of the environment can be the same as, respectively, the first and second states of the environment.

As another example, the state prediction neural network can be trained by, for a plurality of the example planning tasks: generating, from the example planning task, a training example comprising a representation of a first state of the environment at a first planning step and a representation of a second state of the environment at a second, later, e.g. next planning step. The state prediction neural network can then be trained, using any suitable training objective, to process the representation of the second state of the environment to generate the representation of the first state of the environment, and to process the representation of the first state of the environment to generate the representation of the second state of the environment.

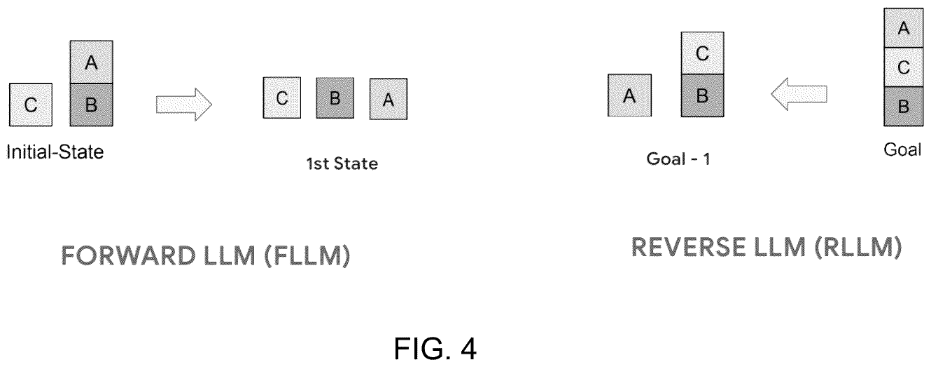

FIG. 4 is a visualization of such a technique for training a state prediction neural network for use in bidirectional planning.

It is known to equip LLMs and VLMs with “tools” that are computer programs, often specialized to perform particular tasks, to facilitate performing a task. An LLM or VLM can interact with such a tool, e.g. by generating API calls. The planning described herein can involve interacting with one or more such tools, e.g. an intermediate state of the environment may be a state that includes an interaction with one or more tools.

The system can be incorporated into a consumer electronic device such as a digital assistant, mobile device, e.g. a mobile phone, or smart speaker. The observation of the initial state may then be provided by a user of the device, e.g. by capturing an image or video and/or user audio describing the initial state, and/or by inputting text either directly or indirectly, e.g. by speaking to a device that includes a speech recognition system. The system can include an interface to receive the observation and to provide the system output i.e. a result of the planning process, e.g. as text, images, audio, or a combination of these. In this way a user can be assisted to perform a particular task, e.g. cleaning or repairing a piece of machinery, cooking, or any other task.

In general the above described techniques can be used for planning any type of task. A few illustrative examples follow.

In some applications the target state of the environment may be derived from a definition of the task, and may be defined at a high level. The intermediate states can, in some cases, define primitive actions, or “skills”, to be performed by another (trained) agent.

As one example, in a coding environment a target state may be defined as a state in which a computer program has no bugs or malware, or in which a target execution speed, memory use limit, or compute use limit is achieved, and so forth. The observation of the first (initial) state of an environment may comprise a current version of source or executable code for the computer program, and the definition of a target state of the environment may comprise a placeholder for a computer program and a definition that the program has no bugs or malware, or meets the target execution speed, or memory or compute use. The intermediate states of the environment may then define intermediate versions of the computer program that lead towards a final state in which the placeholder includes code for a program that meets the requirements. An observation of a state may include, e.g., one or more of code, or a code snippet, a program log, error message or exception, OpenTelemetry data, a result of compiling or executing the code, and so forth. A corresponding approach can be used in some of the other examples given below.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the mechanical agent, e.g. robot, may be interacting with the environment to accomplish a specific task, e.g., to locate or manipulate an object of interest in the environment or to move an object of interest to a specified location in the environment or to navigate to a specified destination in the environment.

In these implementations, a state may be defined by, e.g., one or more of: images, object position data, and sensor data of the agent, for example sensor data from an image, distance, or position sensor or from an actuator. For example in the case of a robot, a state may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle a state may similarly include one or more of the position, linear or angular velocity, force, torque or acceleration, and global or relative pose of one or more parts of the agent. A state may be defined in 1, 2 or 3 dimensions, and may be absolute and/or relative. The state may also include, for example, sensed electronic signals such as motor current or a temperature signal; and/or image or video data for example from a camera or a LIDAR sensor, e.g., data from sensors of the agent or data from sensors that are located separately from the agent in the environment.

In some cases, the state may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle. The actions may be language actions that are in turn used to generate control data to control the robot or other mechanical agent.

The target state may relate to approaching or achieving one or more target locations, one or more target poses, or one or more other target configurations, e.g. for a robot arm to reaching a position or pose. A target state may also be associated with avoiding collision of a part of a mechanical agent with an entity such as an object or wall or barrier. A target state may depend on any of the previously mentioned features e.g. robot or vehicle positions or poses. For example in the case of a robot a target state may depend on a joint orientation (angle) or speed/velocity e.g. to limit motion speed, an end-effector position, a center-of-mass position, or the positions and/or orientations of groups of body parts. A target state may also or instead be associated with force applied by an actuator or end-effector, e.g. dependent upon a threshold or maximum applied force when interacting with an object; or with a torque applied by a part of a mechanical agent. In another example a target state may also or instead be dependent upon energy or power usage, excessive motion speed, one or more positions of one or more robot body parts. Where the agent or robot comprises an autonomous or semi-autonomous moving vehicle similar target state may apply. Also or instead such an agent or robot may have a target state relating to physical movement of the vehicle, e.g. dependent upon energy or power use whilst moving e.g. to define a maximum or average energy use, speed of movement, a route taken when moving e.g. to penalize a longer route over a shorter route between two points, as measured by distance or time. Such an agent or robot may be used to perform a task such as warehouse, logistics, or factory automation, e.g. collecting, placing, or moving stored goods or goods or parts of goods during their manufacture; or the task performed may comprise a package delivery control task. Thus the actions may include actions relating to steering or other direction control actions, and the states may include the positions or motions of other agents e.g. other vehicles or robots.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some agent control implementations the agent may be a human agent and the environment may be a real-world environment. For example the agent can be a human user of a digital assistant such as a smart speaker, smart display, or some other device that is used to instruct the user to perform actions. The task may be any real-world task that the user wishes to perform. The initial state may be obtained from an observation capture subsystem, e.g. a monitoring system such as a video camera or sound capture system, to capture a visual observation of the user performing the task. The actions may comprise instructions in the form of, e.g., text, image, video, or audio data such as speech, that guide the user in performing the task. Thus the actions can be language actions that control (instruct) the human, e.g. using natural language or images, to perform actions in the real-world environment to perform the task. A language action may be an action that outputs a natural language sentence, e.g. by defining a sequence of language tokens, e.g. words or wordpieces, to be emitted at sequential time steps. Thus the agent may comprise a user interface device such as a digital device (a “digital assistant”), e.g. a smart speaker or smart display or other device, e.g. with a natural language input and/or output, that controls (instructs) a human user to perform a task. In general such a digital device can be a mobile device with a natural language interface to receive natural language requests from a human user and to provide natural language responses. It may also include a vision based input e.g. a camera and/or display screen. The digital device may include a language model or language generation neural network system either stored locally, or accessed remotely, or both. The user interface device may comprise, e.g., a mobile device, a keyboard (and optionally display), or a speech-based input mechanism, e.g. to input audio data characterizing a speech waveform of speech representing the input from the user in the natural or computer language and to convert the audio data into tokens representing the speech in the natural or computer language, i.e. representing a transcription of the spoken input. The user interface can also include a text or speech-based output, e.g. a display and/or a text-to-speech subsystem. Thus in implementations the agent actions contribute to performing the task. A monitoring system, e.g. a video camera system, may be provided for monitoring the action (if any) which the user actually performs at each time step in case, e.g. due to human error, it is different from the action which the reinforcement learning system instructed the user to perform. The monitoring system can be used to determine whether the task has been completed. Training data may be collected by recording the actions which the user actually performed based on the instruction. A system of this type can learn how to guide a human to perform a task, e.g. avoiding difficult to perform actions.

In some implementations the environment is a real-world manufacturing environment for manufacturing a product, such as a chemical, biological, or mechanical product, or a food product. As used herein, “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The target state may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use of a resource the metric may comprise any metric of usage of the resource.

In general, a state of the environment may comprise any electronic signals representing the functioning of electronic and/or mechanical items of equipment. For example the initial state of the environment may include observations made by sensors sensing a state of the manufacturing environment, e.g. sensors sensing a state or configuration of the manufacturing units or machines, or sensors sensing movement of material between the manufacturing units or machines. As some examples, such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The initial observation may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment such as a heater, a cooler, a humidifier, or other hardware that modifies a property of air in the real-world environment. The task may comprise a task to control, e.g. minimize, use of a resource, such as a task to control electrical power consumption, or water consumption, and a corresponding target state may be defined. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general the observation of the initial state of the environment may comprise any electronic signals representing the functioning of the facility or of equipment in the facility. For example the initial observation may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The target state may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility, and a corresponding target state may be defined. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The target state may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid a metric defined by a target state may relate to a measure of electrical power or energy transferred to the grid, or to a measure of electrical power or energy loss in the power generation facility.

In general the initial observation of the state of the environment may comprise any electronic signals representing the electrical or mechanical functioning of power generation equipment in the power generation facility, e.g. derived from observations made by any sensors sensing a physical or electrical state of equipment in the power generation facility that is generating electrical power, or the physical environment of such equipment, or a condition of ancillary equipment supporting power generation equipment. Such observations may thus include observations of wind levels or solar irradiance, or of local time, date, or season. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. The initial observation of a state of the environment may also comprise one or more predictions regarding future conditions of operation of the power generation equipment such as predictions of future wind levels or solar irradiance or predictions of a future electrical condition of the grid.

In some implementations, the environment is a chemical synthesis or protein folding environment such that each state is a respective state of a protein chain or of one or more intermediates or precursor chemicals. The agent can be a computer system for determining how to fold the protein chain or synthesize the chemical. In this example, the actions are possible folding actions for folding the protein chain or actions for assembling precursor chemicals/intermediates and the result to be achieved, defined by the target state, may include, e.g., folding the protein so that the protein is stable and so that it achieves a particular biological function or providing a valid synthetic route for the chemical. As another example, the agent may be a mechanical agent that indirectly performs or controls the protein folding actions, or chemical synthesis steps, e.g. by controlling synthesis steps selected by the system automatically without human interaction. The observation of the initial state may comprise a direct or indirect observation of a state of the protein or chemical/intermediates/precursors and/or may be derived from simulation. Thus the system may be used to automatically determine and/or synthesize a protein with a particular function such as having a binding site shape, e.g. a ligand that binds with sufficient affinity for a biological effect that it can be used as a drug. For example e.g. it may be an agonist or antagonist of a receptor or enzyme; or it may be an antibody configured to bind to an antibody target such as a virus coat protein, or a protein expressed on a cancer cell, e.g. to act as an agonist for a particular receptor or to prevent binding of another ligand and hence prevent activation of a relevant biological pathway.

In a similar way the environment may be a drug design environment such that each state is a respective state of a potential pharmaceutically active compound, i.e. a drug, and the agent is a computer system for determining elements of the pharmaceutically active compound and/or a synthetic pathway for the pharmaceutically active compound. The initial state may include, e.g. one or more of starting materials, intermediates, and chemical or physical structures. The drug/synthesis may be designed based on a target state derived from a target for the pharmaceutically active compound, for example in simulation. The agent may be, or may include, a mechanical agent that performs or controls synthesis of the pharmaceutically active compound; and hence a process as described herein may include making such a pharmaceutically active compound.

For example the environment may be an in silico drug design environment, e.g., a molecular docking environment, and the agent may be a computer system for determining elements or a chemical structure of the drug. The drug may be a small molecule or biologic drug. A state may be a state of a simulated combination of the drug and a target of the drug. An action may be an action to modify the relative position, pose or conformation of the drug and drug target (or this may be performed automatically) and/or an action to modify a chemical composition of the drug and/or to select a candidate drug from a library of candidates. A target state may be defined based on, e.g., one or more of: a measure of an interaction between the drug and the drug target, e.g., of a fit or binding between the drug and the drug target; an estimated potency of the drug; an estimated selectivity of the drug; an estimated toxicity of the drug; an estimated pharmacokinetic characteristic of the drug; an estimated bioavailability of the drug; an estimated ease of synthesis of the drug; and one or more fundamental chemical properties of the drug. A measure of interaction between the drug and drug target may depend on e.g. a protein-ligand bonding, van der Waal interactions, electrostatic interactions, and/or a contact surface region or energy; it may comprise, e.g., a docking score. Following identification of elements or a chemical structure of a drug in simulation, the method may further comprise making the drug. The drug may be made partly or completely by an automatic chemical synthesis system.

In some implementations the agent may be a software agent i.e. a computer program, configured to perform a task. For example the environment may be a circuit or an integrated circuit design or routing environment and the agent may be configured to perform a design or routing task for routing interconnection lines of a circuit or of an integrated circuit e.g. an ASIC. The target state may then be dependent on one or more routing metrics such as interconnect length, resistance, capacitance, impedance, loss, speed or propagation delay; and/or physical line parameters such as width, thickness or geometry, and design rules. The target state may also or instead include one or more reward(s) relating to a global property of the routed circuitry e.g. component density, operating speed, power consumption, material usage, a cooling requirement, level of electromagnetic emissions, and so forth. The states may comprise, e.g., component positions and interconnections; the actions may comprise component placing actions e.g. to define a component position or orientation and/or interconnect routing actions e.g. interconnect selection and/or placement actions. The task may be, e.g., to optimize circuit operation to reduce electrical losses, local or external interference, or heat generation, or to increase operating speed, or to minimize or optimize usage of available circuit area, and a corresponding target state may be defined. The method may include making the circuit or integrated circuit to the design, or with interconnection lines routed as determined by the method.

In some implementations the agent is a software agent and the environment is a real-world computing environment. In one example the agent manages distribution of tasks across computing resources e.g. on a mobile device and/or in a data center. In these applications, the initial observation may include an observation of computing resources such as compute and/or memory capacity, or Internet-accessible resources; and the actions may include assigning tasks to particular computing resources. As one example the target state may be configured to maximize or minimize one or more of: utilization of computing resources, electrical power, bandwidth, and computation speed. As another example the target state may relate to one or more metrics of processing the tasks/jobs using the computing resources, e.g. metrics of usage of computational resources, bandwidth, or electrical power, or metrics of processing time, or numerical accuracy, or one or more metrics that relate to a desired load balancing between the computing resources.

In another example the software agent manages the processing, e.g. by one or more real-world servers, of a queue of continuously arriving jobs. The initial observation may comprise an observation of the times of departures of successive jobs, or the time intervals between the departures of successive jobs, or the time a server takes to process each job, e.g. the start and end of a range of times, or the arrival times, or time intervals between the arrivals, of successive jobs, or data characterizing the type of job(s). The actions may comprise actions that allocate particular jobs to particular computing resources; the target state may be to minimize an overall queueing or processing time or the queueing or processing time for one or more individual jobs, or in general to optimize any metric based on the observations.

As another example the environment may comprise a real-world computer system or network, the initial observation may comprise any observation characterizing operation of the computer system or network, the actions performed by the software agent may comprise actions to control the operation e.g. to limit or correct abnormal or undesired operation e.g. because of the presence of a virus or other security breach, and the target state may comprise any metric(s) that characterizing desired operation of the computer system or network.

In some implementations the environment is a data packet communications network environment, and the agent is part of a router to route packets of data over the communications network. The actions may comprise data packet routing actions and the initial observation may comprise e.g. an observation of a routing table which includes routing metrics such as a metric of routing path length, bandwidth, load, hop count, path cost, delay, maximum transmission unit (MTU), and reliability. The target state may be defined in relation to one or more of the routing metrics i.e. configured to maximize one or more of the routing metrics.

In some other implementations the environment is an Internet or mobile communications environment and the agent is a software agent which manages a personalized recommendation for a user. The initial observation may comprise previous actions taken by the user, e.g. features characterizing these; the actions may include actions recommending items such as content items to a user. The target state may be to maximize one or more of: an estimated likelihood that the user will respond favorably to being recommended the (content) item, a suitability unsuitability of one or more recommended items, a cost of the recommended item(s), and a number of recommendations received by the user, optionally within a time span.

As a further example, the actions may include presenting advertisements, the observations may include advertisement impressions or a click-through count or rate, and the target state may characterize previous selections of items or content taken by one or more users.

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The initial observation may characterize the entity, e.g. a mechanical shape or an electrical, mechanical, or electro-mechanical configuration of the entity, or parameters or properties of the entity. The actions may comprise actions that modify the entity e.g. that modify one or more of the observations. The target state may comprise one or more metric of performance of the design of the entity. For example target state may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus the design of an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to plan actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In the above described applications the same observations, actions, rewards and costs may be applied to a simulation of the agent in a simulation of the real-world environment. Once the system has been trained in the simulation, e.g. once the neural networks of the system/method have been trained, the system/method be used to control the real-world agent in the real-world environment. That is actions, or control signals to control actions, generated by the system/method may be used to control the real-world agent to perform a task in the real-world environment in response to observations from the real-world environment.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The essential elements of a computer include a CPU for executing instructions and one or more memory devices for storing instructions and data. The specific configuration of processing units and memory will depend on factors like the complexity of the AI model, the volume of data being processed, and the desired performance and latency requirements.

Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Further aspects of the invention are defined in the following clauses:

A method of training a reverse state prediction neural network for use in a method as described above, comprising: obtaining a training dataset comprising a plurality of example planning tasks, each planning task comprising a sequence of states of an environment at respective a sequence of respective planning steps, leading from an initial state of the environment to a target state of the environment; training the reverse state prediction neural network by, for a plurality of the example planning tasks: generating, from the example planning task, a training example comprising a representation of a first state of the environment at a first planning step and a representation of a second state of the environment at a second, later planning step; and training the reverse state prediction neural network to process the representation of the second state of the environment to generate the representation of the first state of the environment.

In some implementations of this method training the reverse state prediction neural network comprises training the state prediction neural network. The method can further comprise: training the state prediction neural network by, for a plurality of the example planning tasks: generating, from the example planning task, a training example comprising a representation of a third state of the environment at a third planning step and a representation of a fourth state of the environment at a fourth, later planning step; and training the state prediction neural network to process the representation of the third state of the environment to generate the representation of the fourth state of the environment.

In another aspect a method of training a state prediction neural network comprises: obtaining a training dataset comprising a plurality of example planning tasks, each planning task comprising a sequence of states of an environment at respective a sequence of respective planning steps, leading from an initial state of the environment to a target state of the environment; training the state prediction neural network by, for a plurality of the example planning tasks: generating, from the example planning task, a training example comprising a representation of a first state of the environment at a first planning step and a representation of a second state of the environment at a second, later planning step; training the state prediction neural network to process the representation of the second state of the environment to generate the representation of the first state of the environment; and training the state prediction neural network to process the representation of the first state of the environment to generate the representation of the second state of the environment.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, comprising:
obtaining an observation of a first state of an environment;
obtaining a definition of a target state of the environment; and
predicting representations of one or more intermediate states of the environment between the first state and the target state by, at a one or more planning iterations:
either i) updating a representation of a current reverse state of the environment by processing the representation of the current reverse state of the environment and a representation of a current forward state of the environment using a reverse state prediction neural network to generate a representation of a predecessor state of the environment to the current reverse state, and
updating the representation of the current forward state of the environment by processing the representation of the current forward state of the environment and the representation of the predecessor state of the environment using a forward state prediction neural network to generate a representation of a next forward state after the current forward state,
or ii) updating a representation of a current forward state of the environment by processing the representation of the current forward state of the environment and a representation of a current reverse state of the environment using a forward state prediction neural network to generate a representation of a next forward state of the environment after the current forward state, and
updating the representation of the current reverse state of the environment by processing the representation of the current reverse state of the environment and the representation of the next forward state of the environment using a reverse state prediction neural network to generate a representation of a predecessor state to the current reverse state; and
wherein at a first iteration the current forward state of the environment is the first state of the environment and the current reverse state of the environment is the target state of the environment.

2. The method of claim 1, wherein each of the one or more intermediate states corresponds to a respective planning step, wherein the next forward state corresponds to a next planning step after the planning step for the current forward state, and wherein the predecessor state to the current reverse state corresponds to a previous planning step before the planning step for the current reverse state, and wherein a result of the method comprises representations for each of a sequence of intermediate states that lead from the first state to the target state.

3. The method of claim 1, comprising performing the planning iterations until the representations of the current forward state of the environment and the current reverse state of the environment match.

4. The method of claim 1, further comprising:
generating a confidence score associated with the representation of one of the intermediate states at each of the planning iterations; and
guiding the predicting of the representations of the one or more intermediate states of the environment using the confidence score.

5. The method of claim 4, wherein guiding the predicting of the representations of the one or more intermediate states of the environment using the confidence score comprises:
constraining the confidence score to increase monotonically over the planning iterations by regenerating one or more of the intermediate states of the environment when the confidence score for a planning iteration does not increase.

6. The method of claim 4, comprising:
generating a plurality of representations of one of the intermediate states at each of the planning iterations;
generating the confidence score for each of the plurality of representations; and
selecting one of the plurality of representations using the generated confidence scores.

7. The method of claim 1, further comprising, at a current planning iteration:
either i) processing the representation of the current forward state of the environment and the representation of the predecessor state using the forward state prediction neural network to generate the representation of the next forward state and an associated confidence score for the next forward state at the current planning iteration,
or ii) processing the representation of the current reverse state of the environment and the representation of the next forward state using the reverse state prediction neural network to generate the representation of the predecessor state and an associated confidence score for the predecessor state at the current planning iteration; and
in response to determining that the confidence score at the current planning iteration is not greater than the confidence score at a previous planning iteration resampling, respectively, either i) the representation of the next forward state, or ii) the representation of the predecessor state.

8. The method of claim 1, further comprising, at a current planning iteration:
either i) processing the representation of the current forward state of the environment and the representation of the predecessor state using the forward state prediction neural network to generate a plurality of representations of the next forward state and associated confidence scores, and selecting one of the plurality of representations as the representation of the next forward state at the current planning iteration based on the associated confidence scores;
or ii) processing the representation of the current reverse state of the environment and the representation of the next forward state using the reverse state prediction neural network to generate a plurality of representations of the predecessor state and associated confidence scores, and selecting one of the plurality of representations as the representation of the predecessor state at the current planning iteration based on the associated confidence scores.

9. The method of claim 1, wherein
the representation of the current reverse state of the environment, the representation of the current forward state of the environment the representation of the predecessor state, and the representation of the next forward state each comprise a sequence of one or more tokens.

10. The method of claim 9, further comprising:
generating a confidence score associated with the representation of one of the intermediate states at each of the planning iterations; and
guiding the predicting of the representations of the one or more intermediate states of the environment using the confidence score;
wherein generating the confidence score associated with a representation of a state of the environment comprises:
determining a log likelihood value assigned to each token of the sequence of tokens representing the state of the environment; and
determining the confidence score from a sum of log likelihood values.

11. The method of claim 9, comprising:
either i) processing a concatenation of tokens representing the current reverse state of the environment and the current forward state of the environment, using the reverse state prediction neural network, to generate a sequence of tokens representing the predecessor state, and
processing a concatenation of tokens representing the current forward state of the environment and the predecessor state, using the forward state prediction neural network, to generate a sequence of tokens representing the next forward state,
or ii) processing a concatenation of tokens representing the current forward state of the environment and the current reverse state of the environment, using the forward state prediction neural network, to generate a sequence of tokens representing the next forward state, and
processing a concatenation of tokens representing the current reverse state of the environment and the next forward state of the environment, using the reverse state prediction neural network, to generate a sequence of tokens representing the predecessor state.

12. The method of claim 9, wherein processing the representation of the current reverse state of the environment and either i) the representation of the current state of the environment or ii) the representation of the next forward state of the environment, using the reverse state prediction neural network, to generate the representation of the predecessor state comprises:
reversing an order of the sequence of tokens representing the current reverse state of the environment; and
reversing an order of the sequence of tokens representing either the current state of the environment or the next forward state of the environment.

13. The method of claim 9, comprising:
processing the observation using a tokenizer to obtain a first sequence of tokens representing the current forward state of the environment at the first iteration; and
processing the definition of the target state of the environment using the tokenizer to obtain a target sequence of tokens representing the current reverse state of the environment at the first iteration.

14. The method of claim 1, wherein the reverse state prediction neural network and the forward state prediction neural network each comprises a Transformer neural network.

15. The method of claim 1, wherein the reverse state prediction neural network and the forward state prediction neural network are the same state prediction neural network.

16. The method of claim 1, further comprising determining a sequence of actions, based on the predicted intermediate states of the environment, for controlling an agent to reach the target state.

17. The method of claim 16, wherein controlling the agent based on the predicted intermediate states of the environment comprises selecting actions for the agent to perform to transition from the first state of the environment to the target state of the environment via the predicted one or more intermediate states of the environment.

18. The method of claim 16, wherein the agent is a mechanical agent, and the environment is a real-world environment or a simulation of the real-world environment, the method comprising controlling the mechanical agent, based on the predicted intermediate states of the real-world or simulated environment, to reach the target state of the real-world environment to perform a task.

19. One or more non-transitory computer storage media storing instructions that when executed by one or more computers cause the one or more computers to perform operations comprising:
obtaining an observation of a first state of an environment;
obtaining a definition of a target state of the environment; and
predicting representations of one or more intermediate states of the environment between the first state and the target state by, at a one or more planning iterations:
either i) updating a representation of a current reverse state of the environment by processing the representation of the current reverse state of the environment and a representation of a current forward state of the environment using a reverse state prediction neural network to generate a representation of a predecessor state of the environment to the current reverse state, and
updating the representation of the current forward state of the environment by processing the representation of the current forward state of the environment and the representation of the predecessor state of the environment using a forward state prediction neural network to generate a representation of a next forward state after the current forward state,
or ii) updating a representation of a current forward state of the environment by processing the representation of the current forward state of the environment and a representation of a current reverse state of the environment using a forward state prediction neural network to generate a representation of a next forward state of the environment after the current forward state, and
updating the representation of the current reverse state of the environment by processing the representation of the current reverse state of the environment and the representation of the next forward state of the environment using a reverse state prediction neural network to generate a representation of a predecessor state to the current reverse state; and
wherein at a first iteration the current forward state of the environment is the first state of the environment and the current reverse state of the environment is the target state of the environment.

20. A system comprising one or more computers and one or more storage devices communicatively coupled to the one or more computers, wherein the one or more storage devices store instructions that, when executed by the one or more computers, cause the one or more computers to perform operations comprising:
obtaining an observation of a first state of an environment;
obtaining a definition of a target state of the environment; and
predicting representations of one or more intermediate states of the environment between the first state and the target state by, at a one or more planning iterations:
either i) updating a representation of a current reverse state of the environment by processing the representation of the current reverse state of the environment and a representation of a current forward state of the environment using a reverse state prediction neural network to generate a representation of a predecessor state of the environment to the current reverse state, and
updating the representation of the current forward state of the environment by processing the representation of the current forward state of the environment and the representation of the predecessor state of the environment using a forward state prediction neural network to generate a representation of a next forward state after the current forward state,
or ii) updating a representation of a current forward state of the environment by processing the representation of the current forward state of the environment and a representation of a current reverse state of the environment using a forward state prediction neural network to generate a representation of a next forward state of the environment after the current forward state, and
updating the representation of the current reverse state of the environment by processing the representation of the current reverse state of the environment and the representation of the next forward state of the environment using a reverse state prediction neural network to generate a representation of a predecessor state to the current reverse state; and
wherein at a first iteration the current forward state of the environment is the first state of the environment and the current reverse state of the environment is the target state of the environment.
